(19) United States
(12) Patent Application Publication
(10) Pub. No.: US 2013/0055308 A1
(43) Pub. Date: Feb. 28, 2013

(54) Television Media Application Integration

(71) Applicant: Devkumar Gandhi, Fremont, CA (US)

(72) Inventor: Devkumar Gandhi, Fremont, CA (US)

(21) Appl. No.: 13/221,200

(22) Filed: Aug. 30, 2011

(51) Int. Cl. H04N 7/025; H04N 5/44

(52) U.S. Cl. 725/34; 348/734; 348/E05.096

(57) ABSTRACT

Embodiments herein enable users to manage applications on Television media devices through a Television Media Application Integration (TMAI) platform using a secondary device capable of running applications. The TMAI platform enables controlling of application on Television media device through secondary devices. Further, the TMAI platform enables adaptive behavior of applications on secondary device based on the stage of the interaction of user with the application on Television media device. Furthermore, the TMAI platform enables delivery of advertisements published by advertisement published based on user preferences and publisher preferences. The advertisements may be delivered on Television media devices or secondary devices.

### TECHNICAL FIELD

The embodiments herein relate to Television media integration and, more particularly, to managing applications on Television through an integration platform.

### BACKGROUND

Convergence of technologies has enabled access to distinct media services using a single device. Earlier broadcast, telephony and data services were on different platforms and accessing each of the media by users required use of different devices. However, with convergence, it is now possible to access different media from a single device like a television, a mobile device or a computer.

Media convergence in television devices can be seen in many forms. One form is the Internet Protocol television (IPTV). IPTV is a system through which Internet television services are delivered using the architecture and networking methods of the Internet Protocol Suite over a packet-switched network infrastructure, e.g., the Internet and broadband Internet access networks, instead of being delivered through traditional radio frequency (RF) broadcast, satellite signal, and cable television (CATV) formats. In this form, different media content is delivered through a single communication channel. Another form is the aggregation of devices that allow viewing both broadcast content using either satellite signals or cable television signals or RF signals, and content from the web in the form of websites and on-demand media content like on-demand video, music etc via the Internet. Whichever form the convergence happens, the television sets are evolving into television media devices that host platforms enabling users to consume and experience a variety of media content.

In addition to allowing users to consume both traditional broadcast content and web content, television media devices are also fast adapting themselves to providing a number of applications either in the form of native applications or browser based applications. However, owing to a lack of standard in the platforms for the television media devices, every device manufacturer is coming up a proprietary platform for providing applications. Developers that develop applications for one platform may not use the same application in another platform without porting the application.

Further, owing to varying platforms on which users access content, advertisers and advertising networks do not have a unified way of reaching users through their advertisements. They may have to create campaigns separately for each platform as the platforms may not be compatible with each other, and do not provide a unified view of the target audience to target and advertise.

Furthermore, presently platforms do not allow users to interact with the content they are experiencing, and adapt the content and/or user experience dynamically.

### BRIEF DESCRIPTION OF THE FIGURES

The embodiments herein will be better understood from the following detailed description with reference to the drawings, in which:

FIG. 1 is a block diagram depicting architecture of television application interaction between various entities according to embodiments herein;

FIG. 2 is a block diagram depicting the architecture of a television media device 105, according to embodiments herein;

FIG. 3 is a block diagram depicting the architecture of a secondary device 102, according to embodiments herein;

FIG. 4 is a flow diagram which describes the process of operation of user with TMAI 103 platform, according to embodiments herein;

FIG. 5 is a flow diagram which describes the process of operation of TMAI 103 platform, according to embodiments herein;

FIG. 6 is a flow diagram which describes the process of operation of user interaction with TV media device, according to embodiments herein;

FIG. 7 is a flow diagram which describes the process of operation of advertising on TV media device, according to embodiments herein; and

FIG. 8 is a flow diagram which describes the process of operation of displaying advertisement on TV media device, according to embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The term “communication link” unless otherwise specified means a link that enables communication between multiple devices on a network like the Internet or a wide area network using Internet protocols over cellular technologies such as CDMA or GSM, wireless local area networks as described in the IEEE 802.11 family of specifications, Ultra Wide Band (UWB), WiMAX, or other suitable wireless technologies, a satellite communication network, or a convergence network of technologies that utilizes a combination of wired and wireless communication technologies in both short range and long range communications.

The phrase “Television media device” unless otherwise specified means any device that is capable of delivering multimedia content to users over a communication link.

The phrase “secondary device” unless otherwise specified means any programmable device that is capable of communicating with other network devices to perform a variety of functions including but not limited to controlling applications on a Television media device. Examples of secondary devices include but are not limited to portable devices capable of installing an application that can communicate with other network elements.

The phrase “TMAI platform” unless otherwise specified means a platform that allows for integration at least between developers, advertisement networks, Television media devices, and secondary devices.

The phrase “Television media applications” unless otherwise specified means applications that run on Television media devices that enable consumption of multimedia content by users or that enable interaction on the network with other network elements.

The term “advertisers” unless otherwise specified means entities or network of entities that seek to advertise one or more of a product, a group of products, a service, and a group of services.

The embodiments herein disclose management of Television media applications by using a Television Media Application Integration (TMAI) platform. The examples of Television media applications include but are not limited to specific applications for watching specific channels with live content from content providers like CBS NETWORK or NBC NETWORK, gaming applications available over the network like those available from GOOGLE or YAHOO, on demand content services like NETFLIX, and so on. The TMAI platform integrates multiple parties including but not limited to application developers, advertisement networks, users consuming variety of content available from various networks and content publishers through the platform, and a variety of secondary devices including but not limited to mobile devices that may be used as devices to manage applications. The integration allows for application developers to have a standard platform to write applications for, users to manage all applications either written for the platform or other wise using Television media devices and secondary devices, and advertisement networks to publish advertisements to relevant users based on preferences related to aspects including but not limited to user demographics, user locations, content viewed by users and user defined preferences.

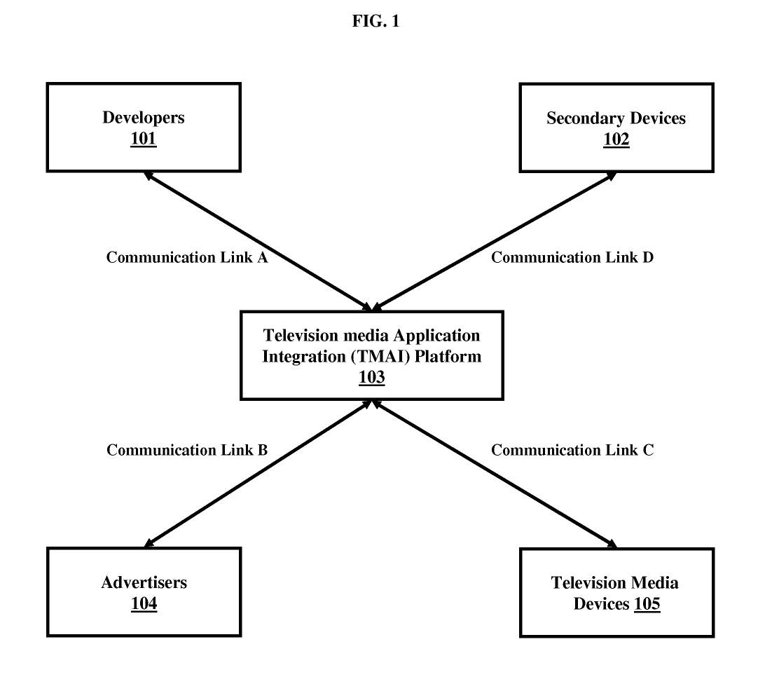

Referring now to the drawings, and more particularly to FIGS. 1 through 8, where similar reference characters denote corresponding features consistently throughout the figures, there are shown embodiments.

### Platform

FIG. 1 is a block diagram depicting architecture of television media application integration (TMAI) between various entities according to embodiments herein. The integration is made possible by a TMAI platform 103. Developers 101 are allowed to develop Television media applications that are compatible with the TMAI platform 103. In a preferred embodiment such development may be aided through a Software Development Kit (SDK) (hereinafter referred to as TMAI SDK). Such applications developed and provided by the developers 101 may be made available via the platform to various users. Users may access the applications available through the TMAI platform 103 using their Television media devices 105. The TMAI platform also allows users to control Television media applications on their Television media devices 105 using an application on their secondary devices 102. Further, advertisers 104 may publish their advertisements on the TMAI platform 103. The TMAI platform 103 delivers advertisements to user devices including Television media devices 105 and secondary devices 102 based on advertiser defined preferences and user defined preferences.

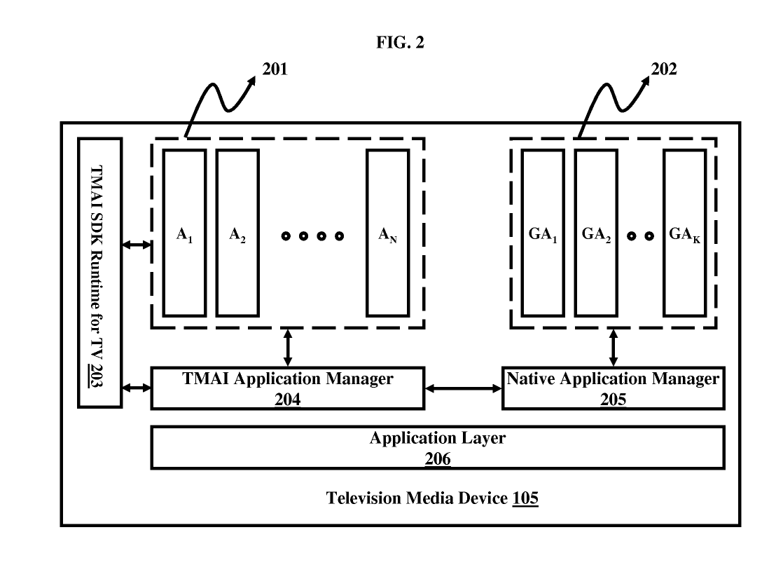

FIG. 2 is a block diagram depicting the architecture of television media device 105, according to embodiments herein. A television media device 105 comprises of application layer 206 that facilitates running various applications on the television media device 105. Further, the television media device 105 comprises of native application manager 205 that controls various general applications 202 that may be installed on the television media device 105. General applications 202 are applications that are not compliant to TMAI SDK. In a preferred embodiment, the television media device 105 also comprises of a TMAI application manager 204 that may be used to control and manage applications 201 that are TMAI SDK compliant (hereinafter referred to as TMAI compliant applications). TMAI application manager 204 interacts with TAMI SDK runtime for TV 203 to manage TMAI compliant applications 201. TAMI SDK Runtime for TV 203 provides the runtime environment to execute TMAI compliant applications 201 on the Television media device 105. TMAI SDK Runtime for TV 203 may also expose API that allows the TMAI Application Manager to manage various functions of the TMAI compliant applications.

Furthermore, the TMAI application manager 204 may interact with the native application manager 205 and control the execution of at least basic functions of general applications 202. Such basic functions of the general applications 202 that the TMAI application manager 204 may control include but not limited to opening of an application, closing of an application, muting an application, adjusting volume of the television media device, adjusting brightness of the television media device, navigating an application, taking snapshots of various states of the application, invoking or instantiating other applications based on content of the application at any given time, controlling advertising on the application, and customizing an application.

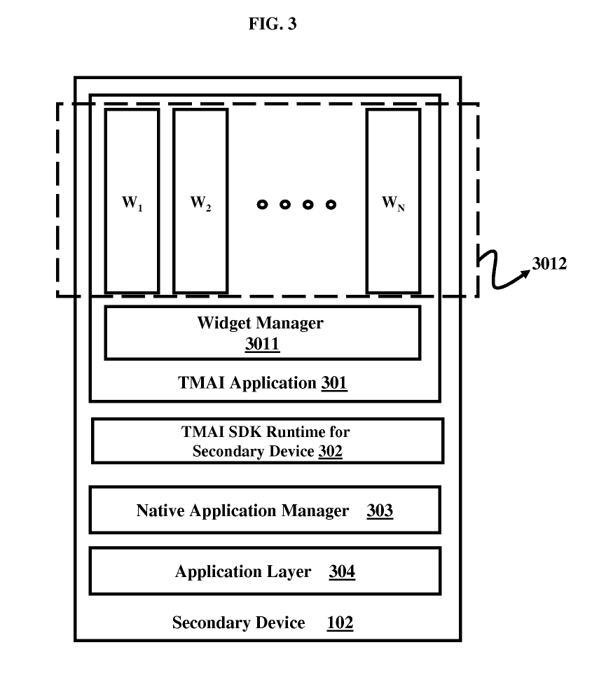

FIG. 3 is a block diagram depicting the architecture of secondary device 102, according to embodiments herein. The secondary device 102 comprises of an application layer 304 to host a variety of applications. The secondary device 102 may further comprise of a native application manager 303 to manage the various applications installed on the device. In a preferred embodiment, user may use the secondary device 102 to control applications on a Television media device 105. A television media device 105 may be controlled using a TMAI application 301 on the secondary device 102. The TMAI application 301 on the secondary device 102 allows for installing multiple widgets 3012 corresponding to applications on a television media device 105. Whenever the user wants to install an application on a television media device 105, the TMAI platform 103 may send the corresponding widget 3012 for download to the TMAI application 301 on the secondary device 102. User then may use the widget 3012 downloaded to control the corresponding application on the television media device 105 by performing various actions on the widget 3012. Such widgets 3012 downloaded are managed by a widget manager module 3011 that is part of the TMAI application 301 on the secondary device 102. In a preferred embodiment, the TMAI application 301 requires the TMAI SDK Runtime for secondary device 302 to run on the secondary device 102.

In various embodiments, the secondary device may have an application manager instead of the TMAI application 301, and the widgets 3012 may be replaced by a set of independent applications that may run without the need for an external container like the TMAI application 301.

In various embodiments, the secondary device 102 may act as a remote control to control applications on a television media device 105. However, it will be evident to an ordinarily skilled person in the art that the “remote control” function of the secondary device 102 is enabled by the TMAI platform 103 using a suitable communication link like the Internet, thereby enabling the secondary device 102 to control any application running on the television media device 105 as opposed to the television media device 105 itself. There exist a number of applications on portable devices that are specifically designed to control certain television sets and/or associated peripheral devices. These applications allow a portable device like a mobile device to act as a remote control for a television set and/or associated peripheral devices. An IPHONE app for controlling APPLETV peripheral device is one such example. Similarly, the remote control application provided by GOOGLE for its ANDROID phones to control a SONY TV with GOOGLETV integrated is another such example. However, such “remote control” applications enable the portable devices to communicate directly with the television sets and/or associated peripheral devices using IR interfaces or local area network means like a WIFI connection, and directly control the television sets and/or associated peripheral devices and not the applications running on the devices. As opposed to direct interaction between a secondary device and the television media device or the associated peripheral devices, the TMAI platform allows for controlling of applications on the Television media device by the secondary device through the TMAI platform.

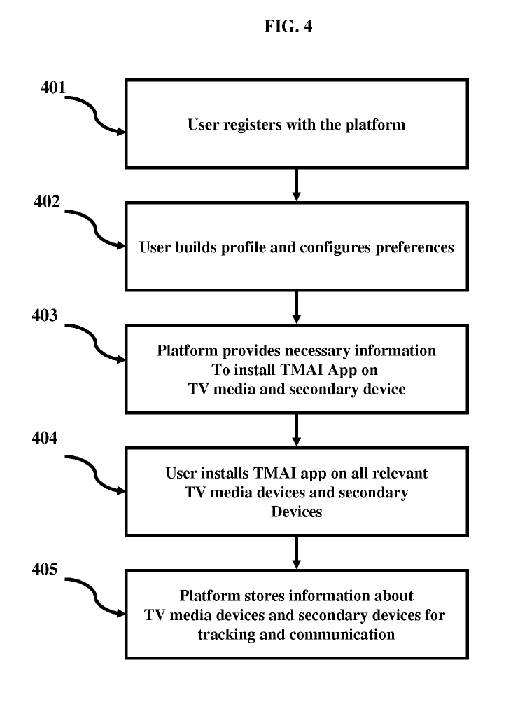

FIG. 4 is a flow diagram which describes the process of operation of user with TMAI platform, according to the embodiments described herein. A user may register (401) on the TMAI platform 103 in order to obtain TMAI applications on his devices. While registering on the TMAI platform 103 the user can configure (402) his preferences and build his profile information. The user may provide preferences information according to his/her interest based on the content he/she may want to watch/consume. For example, a user can provide sports, movies, music as his/her preference for content. Further, user may also build his profile by providing his demographic information, and location information among others. User then may provide (403) necessary information relating to the devices that he would like to use to view the content through TMAI applications and control the TMAI applications. Based on the device information, the TMAI platform 103 may provide necessary information to download the applications onto the devices. User then installs (404) the TMAI manager application on his one or more television media devices 105 and the TMAI application on his one or more secondary devices 102. The platform may store (405) information about the various devices that the user is using tracking and communication.

The various actions in method 400 may be performed in the order presented, in a different order or simultaneously. Further, in some embodiments, some actions listed in FIG. 4 may be omitted.

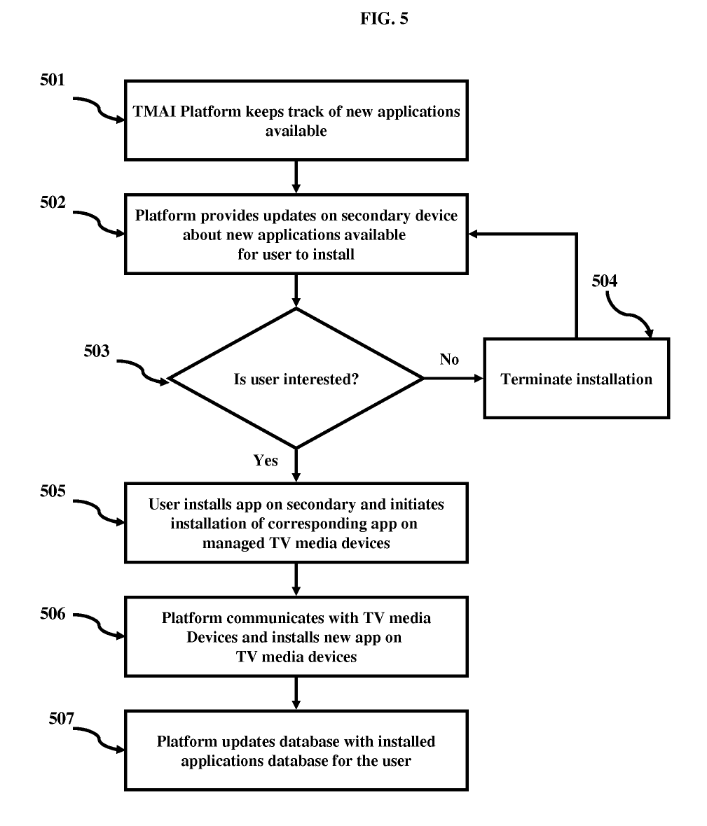

FIG. 5 is a flow diagram which describes the process of operation of TMAI 103 platform, according to the embodiments described herein. TMAI 103 platforms keep track (501) of new applications available. If any new applications have been developed and registered at TMAI 103 platform, the TMAI platform 103 database is updated. The TMAI platform 103 may provide (502) application updates to the secondary device 102 for user to install. The user may update (503) any existing application with the available new version of the application or the user can install a new application on the secondary device 102. If the user is interested in the available new application, the user can install application on secondary device 102 and initiates (505) installation of corresponding application on managed TV media devices. Upon receiving the request for installing the application, the platform communicates (506) with TV media devices and installs new app on TV media devices. Once the application is installed on the secondary device 102 the database is updated (507) with installed applications database for the user. If the user does not want to install any new application the installation terminates (504).

The various actions in method 500 may be performed in the order presented, in a different order or simultaneously. Further, in some embodiments, some actions listed in FIG. 5 may be omitted.

### Secondary Device

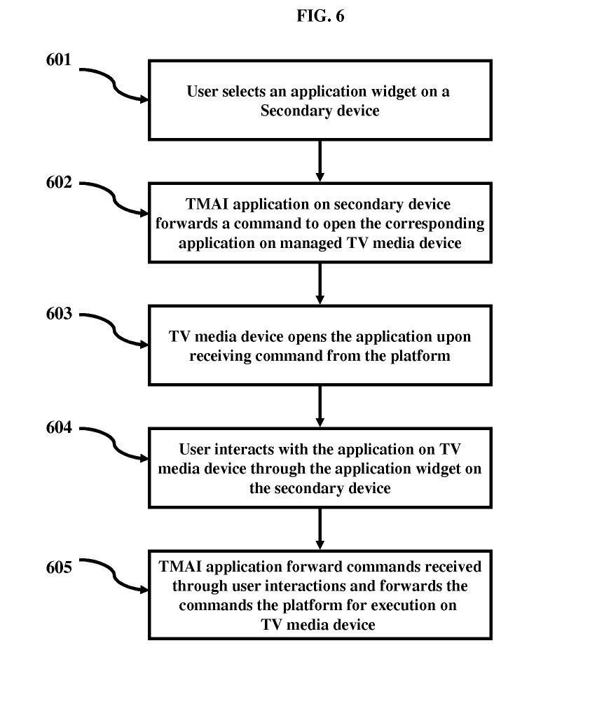

FIG. 6 is a flow diagram which describes the process of operation of user interaction with TV media device, according to the embodiments described herein. The application Widgets 302 are used to control the execution of application on the secondary device 102. The user selects (601) an application Widget 302 on the secondary device 102. TMAI application on secondary device 102 forwards (602) a command to open the corresponding application on managed TV media device. The TV media device opens (603) the application upon receiving command from the platform. User interacts (604) with the application on TV media device through the application Widget 302 on the secondary device 102. TMAI application forwards (605) commands received through user interactions to the TMAI platform for execution on TV media device.

For example, a user may select a Widget 302 on a secondary device 102 such as a mobile. The Widget 302 can be to play and stop a video stream. The TMAI application on the mobile device forwards the command to assign corresponding application on TV media device which may be located locally or remotely. When the user presses the start or stop button on his/her mobile device, corresponding command is passed on to TV media device through the TMAI platform. The command received on the TV media device is subsequently passed on to the TMAI application manager. In a preferred embodiment, the TMAI application manager on the TV media device ultimately processes the command and forwards the right message to the Widget 302 to start or stop processing of the video stream. In some other embodiments, the TMAI application manager forwards the command to the current Widget 302 for taking necessary action to start or stop processing of the video stream.

The various actions in method 600 may be performed in the order presented, in a different order or simultaneously. Further, in some embodiments, some actions listed in FIG. 6 may be omitted.

In various embodiments, the application widgets 302 on the secondary device 102 can be predictive and adaptive in nature. The application widgets 302 can be adaptive by altering the user interface and the controls that are available for a user according to the state of interaction with an application on the managed TV media device. For example, in the context of a gaming application, a certain “level” in the game may require a special control specific to that “level”. Since the application widgets can be made specific to the applications being controlled, the widgets may transform themselves to present different set of controls by predicting the need for changing the user interface according to the events happening on the application on the TV media device. In the gaming example, the application widget used to control the gaming application on the TV media device may predict that the user may enter the next “level” that requires new set of controls. Upon predicting the need for new controls, the application widget may adapt and transform the user interface according to the requirements of the new “level” of the game being played.

In a preferred embodiment, the predictive or adaptive features of secondary device application widgets can be implemented through the use of multi-media identifiers that can be used to communicate information relating to events directly between the TV media device and the secondary device. The identifiers may be in form of video signals, audio signals, and/or alpha numeric identifiers. An example of a video signal may be unique code like a barcode or a QR code displayed on the screen. Such video code may be deciphered by the phone through a scanner integrated on the secondary device. In another example, the identifier can be a audio signal at a certain frequency. In yet another example, the identifier could be an alpha-numeric code. An identifier can be used to identify specific events on a running application on the TV media device. Each application on the TV media device may have one or more associated identifiers. The identifiers can be mapped to specific events. The identifiers may be of varying nature depending on the need of the application and the nature of the events that may be mapped to.

In another embodiment, the predictive and adaptive features of the secondary device application widgets can be implemented by providing support for event based communication of multi-media identifiers between Television media devices and widgets on secondary devices through the TMAI platform.

In various embodiments, the use of identifiers may be used to change the way users navigate a particular application. For example, identifiers may be used to provide access to premium content. In this example, users that have paid for the premium content will be able to register and validate the identifiers through the secondary device application widgets. Upon validating, the user will be able to navigate to consume the premium content.

In a preferred embodiment, the secondary device is a touch based device like an APPLE IPHONE or a GOOGLE ANDROID phone. However, it will be evident to an ordinarily skilled person in the art that the secondary device need not be a cellular device. Any device that is capable of communicating using IP protocols may be used for controlling applications on TV media devices through the TMAI platform.

### AD Network Integration

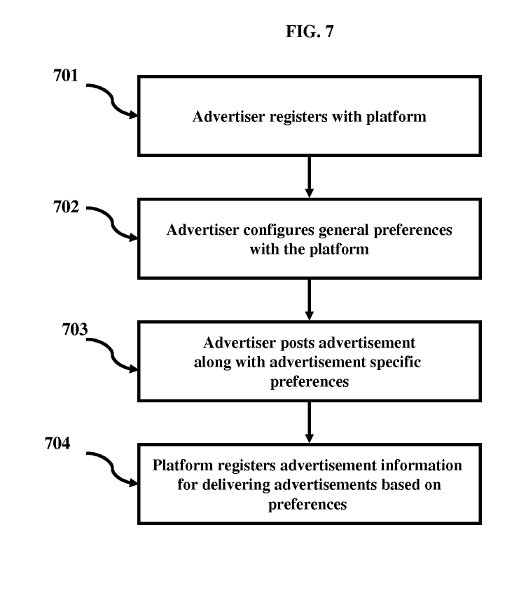

FIG. 7 is a flow diagram which describes the process of operation of advertising on TV media device, according to the embodiments described herein. In an embodiment, the TMAI platform 103 may be used by advertisers 104 to promote their product. Advertisers 104 may register (701) with the TMAI 103 platform. Advertisers 104 may (702) configure general preferences with the TMAI 103 platform for delivering advertisements to their target audience. Once the advertisers 104 configure their preferences, the advertisers 104 may post (703) one or more advertisements along with advertisement specific preferences. Platform checks (704) the advertisement information including advertiser general preferences and advertisement specific preferences against user preferences for delivering advertisements to secondary devices of users with matching preferences. In various embodiments, the advertisements may also be delivered through applications being viewed by the users through their TV media devices. For example, if a user registers his preferences as sports, music and movies, the platform checks against the configuration of advertisers 104. If the preferences of the users and advertisers 104 match, then the relevant advertisement may be published on the secondary device and/or TV media device through one or more applications.

The various actions in method 700 may be performed in the order presented, in a different order or simultaneously. Further, in some embodiments, some actions listed in FIG. 7 may be omitted.

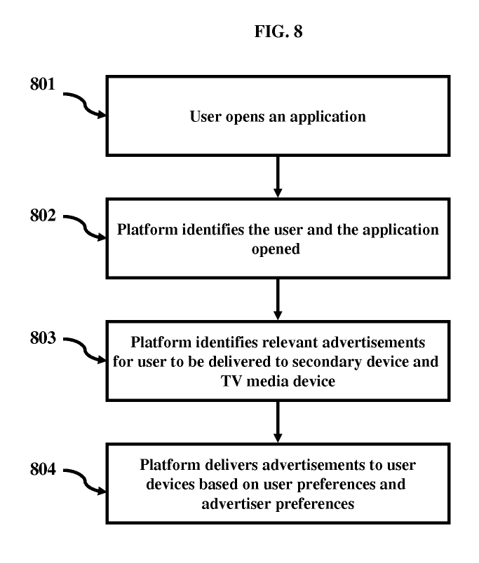

FIG. 8 is a flow diagram which describes the process of operation of displaying advertisement on TV media device, according to the embodiments described herein. A user may open (801) an application to run a TV application. The TMAI platform 103 identifies (802) the user and the application accessed. The platform may retrieve the user preferences and identifies (803) relevant advertisements for the user by matching user preferences with those of the advertisers and advertisements. If a match is found for a particular advertisement with the user, the platform delivers (804) the advertisement to the secondary device 102 based on user preferences and advertiser 104 preferences. In various embodiments, advertisements may also be delivered to TV media devices of users with matching preferences.

In some embodiments, the TMAI platform 103 may deliver advertisements to a user based on the content being consumed by the user. For example, a user may be watching a travel related content through an application on his TV. The TMAI platform 103 identifies the nature of the content that is being consumed and delivers advertisements relating to travel needs on the secondary device based on the content being consumed on the TV application.

In some other embodiments, the TMAI platform 103 may suggest an advertisement of a competing/complimentary product in relation to a product that is being advertised currently on the TV media device of the user based on advertiser preferences or advertisement specific preferences.

The various actions in method 800 may be performed in the order presented, in a different order or simultaneously. Further, in some embodiments, some actions listed in FIG. 8 may be omitted.

The embodiments disclosed herein can be implemented through at least one software program running on at least one hardware device and performing network management functions to control the network elements. The network elements shown in FIGS. 1 through 8 include blocks which can be at least one of a hardware device, or a combination of hardware device and software module.

The embodiment disclosed herein specifies a methods and systems for managing Television media applications using an integration platform. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method of controlling an application on a TV media device, using a secondary device, said method comprising
receiving an input on said secondary device through an application;
sending a command corresponding to said input to a TMAI application platform by said secondary device;
forwarding said command to a TV media device by said TMAI application platform; and
processing said command by an application on said TV media device.

2. The method as in claim 1, wherein said input is a speech input

3. The method as in claim 1, wherein said input is a selection on said application on said secondary device

4. The method as in claim 1, wherein said input is a gesture input

5. The method as in claim 1, wherein said input is a touch based gesture input

6. The method as in claim 1, wherein said input is a text input

7. The method as in claim 1, wherein said application on said TV media device is a TMAI compliant application.

8. The method as in claim 1, wherein said application on said TV media device is a TMAI non-compliant application.

9. The method as in claim 1, said method comprising adapting user interface on said secondary device application for controlling an application on said TV media device, said adapting comprising
recognizing an event by said application on said TV media device;
sending a communication to TMAI platform by said application;
forwarding said communication to said secondary device by said TMAI platform;
receiving said communication by said secondary device application from said TMAI platform;
performing user interface changes by said secondary device application to adapt according to said event.

10. The method as in claim 9, wherein said event is one among end of a portion of said application on said TV media device, and start of a new portion of said application on said TV media device.

11. The method of claim 1, said method comprising adapting user interface on said secondary device application for controlling an application on said TV media device through said TMAI platform, said adapting comprising
recognizing an event by said TMAI platform in an interaction between said TV media device and said secondary device;
sending a communication to said secondary device by said TMAI platform;
receiving said communication by said secondary device application from said TMAI platform;
performing user interface changes by said secondary device application to adapt according to said event.

12. The method as in claim 11, wherein said event is one among end of a portion of said application on said TV media device, and start of a new portion of said application on said TV media device.

13. The method as in claim 1, said method comprising adapting user interface on said secondary device application for controlling an application on said TV media device, said adapting comprising
recognizing an event by said application on said TV media device;
providing a multi-media identifier to indicate said event;
recognizing said multi-media identifier by said secondary device;
performing user interface changes by said secondary device application to adapt according to said event.

14. The method as in claim 13, wherein said event is one among end of a portion of said application on said TV media device, and start of a new portion of said application on said TV media device.

15. The method as in claim 13, wherein said multi-media identifier is a video signal displayed on screen of said TV media device.

16. The method as in claim 15, wherein said multi-media identifier is a QR code displayed on screen

17. The method as in claim 13, wherein said multi-media identifier is an audio signal played out by said TV media device.

18. The method as in claim 17, wherein said multi-media identifier is an audio signal at a pre-defined frequency dedicated for the communication of information relating to said event.

19. A method of delivering an advertisement to a user based on user information, said method comprising
receiving communication on an application being opened on a TV media device by TMAI platform;
identifying user corresponding to said TV media device by said TMAI platform;
matching user preferences with available advertisements for said user by said TMAI platform;
delivering a matched advertisement by said TMAI platform to a group of devices including at least one of TV media device of said user, and one or more secondary devices of said user, based on said user preferences and preferences of advertisement publisher of said matched advertisement.

20. The method as in claim 19, wherein user preferences information includes at least one of content preferences, interest domains, and nature of advertisements preferred.

21. The method as in claim 19, wherein advertisement publisher preferences includes at least one of target audience demographic profile, target audience location information, target audience content preferences, nature of content being consumed by target audience at the time of delivering advertisement, and stage of an application.

22. A system for controlling an application on a TV media device, using a secondary device, said system comprising
an application means on a secondary device for
receiving an input on said secondary device;
sending a command corresponding to said input to a TMAI application platform by said secondary device;
said TMAI application platform for forwarding said command to a TV media device by said TMAI application platform; and
an application means on said TV media device for processing said command by an application.

23. The system as in claim 22, wherein said input is a speech input

24. The system as in claim 22, wherein said input is a selection on said application on said secondary device

25. The system as in claim 22, wherein said input is a gesture input

26. The system as in claim 22, wherein said input is a touch based gesture input

27. The system as in claim 22, wherein said input is a text input

28. The system as in claim 22, wherein said application on said TV media device is a TMAI compliant application.

29. The system as in claim 22, wherein said application on said TV media device is a TMAI non-compliant application.
